(19) United States
(12) Patent Application Publication
(10) Pub. No.: US 2007/0049719 A1
(43) Pub. Date: Mar. 1, 2007

(54) Process for the production of melt-processable polyurethanes

(75) Inventors: Wolfgang Brauer, Leverkuen (DE); Wolfgang Kaufhold, Koln (DE); Herbert Heidingsfeld, Frechen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/507,278

(22) Filed: Aug. 21, 2006

(30) Foreign Application Priority Data
Aug. 24, 2005 (DE) 102005039933.9

(51) Int. Cl. C08G 18/00

(52) U.S. Cl. 528/44

(57) ABSTRACT

The invention relates to a multi-step process for the production of melt-processable polyurethanes with improved processing characteristics, particularly improved homogeneity.

### FIELD OF THE INVENTION

The present invention relates to a multi-step process for the production of melt-processable polyurethanes with improved processing characteristics, particularly with improved homogeneity.

### BACKGROUND OF THE INVENTION

Thermoplastic polyurethane elastomers (TPUs) have been known for a long time. They are of technical importance because of their combination of high-quality mechanical properties with the known advantages of inexpensive melt-processability. A wide variety of mechanical properties can be achieved by using different chemical constituents. An overview of TPUs, their properties and applications is given e.g. in Kunststoffe 68 (1978), pages 819 to 825 or Kautschuk, Gummi, Kunststoffe 35 (1982), pages 568 to 584.

TPUs are built up from linear polyols, usually polyester or polyether polyols, organic diisocyanates and short-chain diols (chain extenders). A wide variety of combinations of properties can be established in a targeted manner via the polyols. To accelerate the formation reaction, catalysts can additionally be used. To establish the properties, the constituents can be varied within relatively broad molar ratios. Molar ratios of polyols to chain extenders of 1:1 to 1:12 have proved suitable. These result in products in the range of 60 Shore A to 75 Shore D.

The melt-processable polyurethane elastomers can be built up either stepwise (prepolymer metering method) or by simultaneous reaction of all the components in one step (one-shot metering process).

TPUs can be prepared continuously or batchwise. The most widely known industrial preparation processes are the belt process (GB-A 1 057 018) and the extruder process (DE-A 19 64 834, DE-A 23 02 564 and DE-A 20 59 570).

To improve the processing characteristics, rapid demoldability of injection moldings and increased melt, tube and profile stability of extruded products, with ready melting of the TPU, are of great interest. The morphology of the TPUs, i.e. their special recrystallization behavior, is of decisive importance for demolding behavior and stability. In addition, side reactions, particularly on the NCO side (formation of allophanates, biurets and triisocyanurates), should be avoided for good homogeneity.

In EP-A 0 571 830, it is described how a TPU with a markedly increased recrystallization temperature compared with TPUs produced in the standard process is obtained in a simple batch process by reaction of 1 mole polyol with 1.1 to 5.0 moles diisocyanate, incorporation of the remaining diisocyanate and subsequent chain extension. In this way, TPUs with improved demoldability and stability of the film bubble are obtained. Because of the production process, however, the products thus obtained give films with “fisheyes” and are therefore unsuitable for processing by extrusion. The elevated melting temperatures are also disadvantageous for processing, particularly in the case of a diisocyanate/polyol ratio of 1.5 to 2.0 described in the examples.

In DE-A 2 248 382, another soft segment prepolymer process is described. By reacting an excess of 1 mole polyol with 0.2 to 0.7 moles of a diisocyanate other than 4,4′-diphenylmethane diisocyanate, an OH-terminated prepolymer is produced to which a chain extender is added in the following step and which is reacted with a diisocyanate different from that in the first step (optionally in one or two steps). In this way, an expansion of the melting range and a slight blooming of low molecular-weight oligomers is achieved. This process also failed to achieve an improvement in recrystallization capacity and thus stability. The resulting products are therefore suitable for coating and calendering, but not for film processing.

In EP-A 0 010 601, a process is described for the continuous production of polyurethane and polyurethane urea elastomers in a screw machine with special screw elements and with component metering of one or two monomer components in at least two portions. Both an NCO prepolymer (NCO excess) and an OH prepolymer (OH excess; 0.3 to 0.8 moles diisocyanate per mole polyol) are used here. The residual quantity of diisocyanate and the chain extender are optionally also added in one or more steps here. Using this process, differences in reactivity in the raw materials are evened out and elastomers are obtained with a reproducible level of properties and with improved limiting bending stress, notched impact resistance and rebound resilience.

A need exists in the art, therefore, for a process for producing TPU's with good stability which in be processed into homogenous shaped articles.

### SUMMARY OF THE INVENTION

The present invention therefore provides a process with which it is possible to produce TPUs with good stability that can be processed into homogeneous shaped articles, particularly films.

Surprisingly, it was possible to achieve this by the multi-step production process according to the invention.

### DETAILED DESCRIPTION OF THE INVENTION

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

The present invention provides a process for the production of melt-processable polyurethane elastomers (TPUs) with improved processing characteristics, by,
A) mixing one or more linear, hydroxyl-terminated polyols a) with a weight-average molecular weight of 500 to 5,000 with an organic diisocyanate b) in an equivalence ratio of NCO-reactive groups to NCO groups of 1.1:1 to 5.0:1 in a mixing unit with high shear energy,
B) reacting the reaction mixture produced in step A) at temperatures of >80° C. to a conversion of >90%, based on component b), to form an OH-terminated prepolymer,
C) mixing the OH prepolymer produced in step B) with one or more chain extenders c) having a molecular weight of 60 to 490, and
D) reacting the mixture produced in step C) with a quantity of component b) to form the thermoplastic polyurethane, such that, an equivalence ratio of NCO groups to NCO-reactive groups of 0.9:1 to 1.1:1 is established,
   wherein steps A) to D) are optionally performed in the presence of catalysts and with the optional addition of 0 to 20 wt. % auxiliary substances and additives, with the weight percentages being based on the total quantity of TPU.

Suitable organic diisocyanates b) are e.g. aliphatic, cycloaliphatic araliphatic, heterocyclic and aromatic diisocyanates, as described e.g. in Justus Liebigs Annalen der Chemie, 562, pages 75 to 136.

The following are mentioned as individual examples: aliphatic diisocyanates, such as hexamethylene diisocyanate, cycloaliphatic diisocyanates, such as isophorone diisocyanate, 1,4-cyclohexane diisocyanate 1-methyl-2,4- and -2,6-cyclohexane diisocyanate, together with the corresponding mixtures of isomers, 4,4′-, 2,4′- and 2,2′-dicyclohexylmethane diisocyanate, together with the corresponding mixtures of isomers, and aromatic diisocyanates, such as 2,4-toluene diisocyanate, mixtures of 2,4- and 2,6-toluene diisocyanate, 4,4′-diphenylmethane diisocyanate, 2,4′-diphenylmethane diisocyanate and 2,2′-diphenylmethane diisocyanate, mixtures of 2,4′-diphenylmethane diisocyanate and 4,4′-diphenylmethane diisocyanate, urethane-modified liquid 4,4′-diphenylmethane diisocyanates and/or 2,4′-diphenylmethane diisocyanates, 4,4′-diisocyanatodiphenylethane-(1,2) and 1,5-naphthylene diisocyanate. It is preferable to use diphenylmethane diisocyanate isomer mixtures with a 4,4′-diphenylmethane diisocyanate content of more than 96 wt. % and particularly 4,4′-diphenylmethane diisocyanate, hexamethylene diisocyanate and 4,4′-, 2,4′- and 2,2′-dicyclohexylmethane diisocyanate together with the corresponding mixtures of isomers. The above diisocyanates can be used individually or in the form of mixtures with one another. They can also be used together with up to 15% (based on total diisocyanate), but no more than a sufficient quantity of a polyisocyanate to give rise to a melt-processable product. Examples are triphenylmethane-4,4′,4″-triisocyanate and polyphenyl polymethylene polyisocyanates.

Linear hydroxyl-terminated polyols are used as polyols a). These often contain small quantities of non-linear compounds resulting from their production. They are often therefore referred to as “substantially linear polyols”

Polyether diols suitable as component a) can be produced by reacting one or more alkylene oxides having 2 to 4 carbon atoms in the alkylene group with a starter molecule containing two bound active hydrogen atoms. Examples of alkylene oxides are: ethylene oxide, 1,2-propylene oxide, epichlorohydrin, 1,2-butylene oxide and 2,3-butylene oxide. Ethylene oxide, propylene oxide and mixtures of 1,2-propylene oxide and ethylene oxide are preferably employed. The alkylene oxides can be used individually, alternately in succession or as mixtures. Suitable as starter molecules are e.g. water, amino alcohols, such as N-alkyldiethanolamines, e.g. N-methyldiethanolamine, and diols, such as ethylene glycol, 1,3-propylene glycol, 1,4-butanediol and 1,6-hexanediol. Mixtures of starter molecules can optionally also be used. Suitable polyetherols are also the hydroxyl group-containing polymerisation products of tetrahydrofuran. Trifunctional polyethers can also be employed in proportions of 0 to 30 wt. %, based on the bifunctional polyethers, but in no more than a sufficient quantity to give rise to a product that is still melt-processable. The substantially linear polyether diols preferably possess number-average molecular weights M̅n of 500 to 5,000. These can be employed both individually and in the form of mixtures with one another.

Suitable polyester diols (component a)) can be produced e.g. from dicarboxylic acids with 2 to 12 carbon atoms, preferably 4 to 6 carbon atoms, and polyhydric alcohols. Suitable dicarboxylic acids are e.g.: aliphatic dicarboxylic acids, such as succinic acid, glutaric acid, adipic acid, suberic acid, azelaic acid and sebacic acid, or aromatic dicarboxylic acids, such as phthalic acid, isophthalic acid and terephthalic acid. The dicarboxylic acids can be employed individually or as mixtures, e.g. in the form of a succinic, glutaric and adipic acid mixture. To produce the polyester diols it may be advantageous to use the corresponding dicarboxylic acid derivatives, such as carboxylic acid diesters with 1 to 4 carbon atoms in the alcohol group, carboxylic acid anhydrides or carboxylic acid chlorides instead of the dicarboxylic acids. Examples of polyhydric alcohols are glycols with 2 to 10, preferably 2 to 6 carbon atoms, e.g. ethylene glycol, diethylene glycol, 1,4-butanediol, 1,5-pentanediol, 1,6-hexanediol, 1,10-decanediol, 2,2-dimethyl-1,3-propanediol, 1,3-propanediol or dipropylene glycol. Esters of carboxylic acid with the above diols are also suitable, particularly those with 4 to 6 carbon atoms, such as 1,4-butanediol or 1,6-hexanediol, condensation products of ω-hydroxycarboxylic acids, such as ω-hydroxycaproic acid, or polymerisation products of lactones, e.g. optionally substituted ω-caprolactones. The polyester diols have number-average molecular weights M̅n of 500 to 5,000, and can be used individually or in the form of mixtures with one another.

Low molecular-weight diols are used as chain extenders c), optionally with small quantities of diamines, with a molecular weight of 60 to 490 g/mole, preferably aliphatic diols with 2 to 14 carbon atoms, such as e.g. ethanediol, 1,6-hexanediol, diethylene glycol, dipropylene glycol and particularly 1,4-butanediol. However, diesters of terephthalic acid with glycols having 2 to 4 carbon atoms, e.g. terephthalic acid bisethylene glycol or terephthalic acid bis-1,4-butanediol, hydroxyalkylene ethers of hydroquinone, such as e.g. 1,4-di(β-hydroxyethyl)hydroquinone, ethoxylated bisphenols, such as e.g. 1,4-di(β-hydroxyethyl)bisphenol A, (cyclo)aliphatic diamines, such as e.g. isophorone diamine, ethylenediamine, 1,2-propylenediamine, 1,3-propylenediamine, N-methylpropylene-1,3-diamine, N,N′-dimethylethylenediamine, and aromatic diamines, such as e.g. 2,4-toluenediamine and 2,6-toluenediamine, 3,5-diethyl-2,4-toluenediamine and/or 3,5-diethyl-2,6-toluenediamine and primary mono-, di-, tri- and/or tetraalkyl-substituted 4,4′-diaminodiphenylmethanes, are also suitable. Preferred as chain extenders are ethanediol, 1,4-butanediol, 1,6-hexanediol; 1,4-di(β-hydroxyethyl) hydroquinone or 1,4-di(β-hydroxyethyl) bisphenol A. Mixtures of the chain extenders named above can also be used. Relatively small quantities of triols can also be added.

In addition, conventional monofunctional compounds can also be used in small quantities, e.g. as chain terminators or mold release agents. Alcohols, such as octanol and stearyl alcohol, or amines, such as butylamine and stearylamine, can be mentioned as examples.

To produce the TPUs in the process of the present invention, the constituents can optionally be reacted in the presence of catalysts, auxiliary substances and/or additives, preferably in quantities such that the equivalence ratio of NCO groups from component b) to the sum of the NCO-reactive groups, particularly the OH (or NH) groups of the low molecular-weight compounds c) and the polyols a) is 0.9:1.0 to 1.1:1.0, preferably 0.95:1.0 to 1.05:1.0.

Suitable catalysts are the conventional tertiary amines known from the prior art, such as e.g. triethylamine, dimethylcyclohexylamine, N-methylmorpholine, N,N′-dimethylpiperazine, 2-(dimethylaminoethoxy)ethanol, diazabicyclo-[2.2.2]-octane and similar, as well as, in particular, organic metal compounds, such as titanic acid esters, iron compounds, tin compounds, e.g. tin diacetate, tin dioctoate, tin dilaurate or the tin dialkyl salts of aliphatic carboxylic acids, such as dibutyltin diacetate, dibutyltin dilaurate or similar. Preferred catalysts are organic metal compounds, particularly titanic acid esters, iron compounds and/or tin compounds. The total quantity of catalysts in the TPUs is generally about 0 to 5 wt. %, preferably 0 to 1 wt. %, based on TPU.

In addition to the reaction components and the catalysts, auxiliary substances and/or additives can also be added up to an amount of 20 wt. %, based on the total quantity of TPU. These can be dissolved in one of the reaction components, preferably in component a), or optionally metered in on completion of the reaction in a downstream mixing unit, such as e.g. an extruder.

The following are mentioned as examples: lubricants, such as fatty acid esters, their metal soaps, fatty acid amides, fatty acid ester amides and silicone compounds, anti-blocking agents, inhibitors, stabilizers against hydrolysis, light, heat and discoloration, flame retardants, dyes, pigments, inorganic and/or organic fillers and reinforcing agents. Reinforcing agents are in particular fibrous reinforcing agents, such as e.g. inorganic fibers, which are produced in accordance with the prior art and can also be provided with a size. Further details on the above-mentioned auxiliary substances and additives can be taken from the specialized literature, e.g. the monograph by J. H. Saunders and K. C. Frisch “High Polymers”, volume XVI, Polyurethane, parts 1 and 2, Interscience Publishers 1962 and 1964 respectively, the Taschenbuch für Kunststoff Additive by R. Gachter and H. Müller (Hanser Verlag Munich 1990) or DE-A 29 01 774.

Other additives that can be incorporated into the TPU are thermoplastics, e.g. polycarbonates and acrylonitrile/butadiene/styrene terpolymers, particularly ABS. Other elastomers, such as rubber, ethylene/vinyl acetate copolymers, styrene/butadiene copolymers and other TPUs can also be employed. Commercial plasticizers, such as phosphates, phthalates, adipates, sebacates and alkylsulfonates are also suitable for incorporation.

The multi-step production process according to the invention can take place batchwise or continuously.

The components for step A) are blended at temperatures above their melting point, preferably at temperatures of 50 to 220° C., in an OH/NCO ratio of 1.1:1 to 5.0:1.

In step B), this mixture is brought to substantially complete conversion, preferably more than 90% (based on the isocyanate component), at temperatures above 80° C., preferably between 100° C. and 250° C. An OH-terminated prepolymer is obtained.

These steps are preferably performed in a mixing unit with high shear energy. For example, it is possible to use a stirrer in a vessel or a mixing head or high-speed tubular mixer, a jet or a static mixer. Static mixers that can be used are described in Chem.-Ing. Techn. 52, part 4, pages 285 to 291, and in “Mischen von Kunststoff und Kautschukprodukten”, VDI-Verlag, Düsseldorf 1993. The so-called SMX static mixers from Sulzer can be mentioned as an example.

In one embodiment of the present invention, a tube can also be used as the reactor for the reaction.

In another embodiment, the reaction can also be carried out in a first section of a multi-screw extruder (e.g. a twin-screw kneader (ZSK)).

In step C), the OH-terminated prepolymer is mixed intensively with the low molecular-weight chain extender c).

The chain extender is preferably incorporated in a mixing unit operating with high shear energy. A mixing head, a static mixer, a jet or a multi-screw extruder can be mentioned as examples.

In step D), the remainder of the diisocyanate b) is incorporated with intensive mixing and the reaction to form the thermoplastic polyurethane is completed, an overall equivalence ratio of NCO groups to NCO-reactive groups of 0.9:1 to 1.1:1 being established in steps A) to D). This incorporation preferably also takes place in a mixing unit operating with high shear energy, such as e.g. a mixing head, a static mixer, a jet or a multi-screw extruder.

The temperatures of the extruder housing selected such that the reaction components are brought to complete conversion and the possible incorporation of the above-mentioned auxiliary substances and/or other components can be performed with maximum product protection.

At the end of the extruder, granulation is performed. Readily processable granules are obtained.

The TPU produced by the process according to the invention can be processed into injection moldings and homogeneous extruded articles, particularly films.

The present invention is further illustrated, but is not to be limited, by the following examples.

### EXAMPLES

Raw Materials Used:

PE 1000 Polyether with a molecular weight of Mₙ=1,000 g/mole;

PES 2250 Butanediol adipate with a molecular weight of Mₙ=2,250 g/mole;

MDI Diphenylmethane 4,4′-diisocyanate

HDI 1,6-Hexamethylene diisocyanate

TDI Toluene diisocyanate

IPDI Isophorone diisocyanate

BUT 1,4-Butanediol

Production (Batch) of the TPUs:

In a reaction vessel, a polyol was heated to 180° C. Dissolved in the polyol was 0.4 wt. %, based on TPU, ethylenebisstearamide (wax). The partial quantity 1 of the diisocyanate (60° C.) was added while stirring (300 rpm). The prepolymer was obtained (conversion >90 mole %). According to the data in Table I, the following were added to the prepolymer while stirring:

a) the butanediol and then, while intermixing intensively, the partial quantity 2 of the diisocyanate (Examples 2, 3, 4, 6, 10, 11, 12, 13, 14) or

b) the partial quantity 2 of the diisocyanate and then, while intermixing intensively, the butanediol (Examples 1, 5, 7, 9) or

c) the partial quantity 2 of the diisocyanate and, at the same time, while intermixing intensively, the butanediol (Examples 8 and 15).

In the examples where HDI was used, approx. 40-100 ppm dibutyltin dilaurate (catalyst), based on polyol, was used. After approx. 20-60 sec (depending on the diisocyanate), the reaction mixture was poured on to a coated plate and conditioned for 30 minutes at 120° C. The cast sheets were cut and granulated. The data relating to quantities and ratios is presented in Table I below.

Processing by Injection Molding:

The granules were melted in a D 60 (32-screw) injection-molding machine from Mannesmann and shaped into sheets (125×50×2 mm). The hardness was measured in accordance with DIN 53505.

Processing into Films:

The granules were melted in a 30/25D single-screw extruder (PLASTICORDER PL 2000-6 from Brabender) (metering 3 kg/h; 230 to 195° C.) and extruded through a flat-film die head to form a flat film.

TABLE I

| | 1 mol | | | | | | | |
|---|---|---|---|---|---|---|---|---|
| | polyol | Mol | OH:NCO | | | TPU | Injection molded | |
| | (Step | Diisocyanate | ratio | | | Hardness | sheet | Flat film |
| Ex. | A + B) | (Step A + B) | (Step A + B) | Step C | Step D | (Shore A) | (Homogeneity) | (Homogeneity) |
| 1* | PES 2250 | 1.5 MDI | 0.67 | 2.1 mol MDI | 2.6 mol BUT | 85 | homogeneous | very inhomogeneous |
| 2 | PES 2250 | 0.67 MDI | 1.50 | 2.6 mol BUT | 2.93 mol MDI | 85 | homogeneous | homogeneous |
| 3* | PES 2250 | 0.67 TDI | 1.50 | 2.6 mol BUT | 2.93 mol MDI | 82 | brown | cannot be processed |
| 4* | PES 2250 | 0.67 MDI | 1.50 | 2.6 mol BUT | 2.93 mol TDI | | cannot be processed | cannot be processed |
| 5* | PE 1000 | 1.5 MDI | 0.67 | 0.5 mol MDI | 1.0 mol BUT | 80 | homogeneous | inhomogeneous |
| 6 | PE 1000 | 0.67 MDI | 1.50 | 1.0 mol BUT | 1.33 mol MDI | 80 | homogeneous | homogeneous |
| 7* | PE 1000 | 0.67 MDI | 1.50 | 1.33 mol MDI | 1.0 mol BUT | 80 | homogeneous | very inhomogeneous |
| 8* | PE 1000 | 0.67 MDI | 1.50 | 1.33 mol MDI | — | 80 | homogeneous | inhomogeneous |
| | | | | 1.0 mol BUT | | | | |
| 9* | PES 2250 | 1.50 mol HDI | 0.67 | 2.1 mol HDI | 2.6 mol BUT | 93 | very inhomogeneous | very inhomogeneous |
| 10 | PES 2250 | 0.67 mol HDI | 1.50 | 2.6 mol BUT | 2.93 mol HDI | 93 | homogeneous | homogeneous |
| 11* | PES 2250 | 0.67 mol HDI | 1.50 | 2.6 mol BUT | 2.93 mol MDI | | very inhomogeneous | |
| 12* | PES 2250 | 0.67 mol MDI | 1.50 | 2.6 mol BUT | 2.93 mol HDI | | very inhomogeneous | |
| 13* | PES 2250 | 0.67 mol IPDI | 1.50 | 2.6 mol BUT | 2.93 mol HDI | | very inhomogeneous | |
| 14* | PES 2250 | 0.67 mol HDI | 1.50 | 2.6 mol BUT | 2.93 mol IPDI | | cannot be processed | |
| 15* | PES 2250 | 0.67 mol HDI | 1.50 | 2.6 mol BUT | — | 94 | inhomogeneous | inhomogeneous |
| | | | | 2.93 mol HDI | | | | |

*Comparative examples not according to the invention.

The results from the above Table I clearly show that homogeneous films and sheets can only be produced with the TPUs produced according to the invention, whereas with the TPUs produced as comparisons according to the prior art, either only inhomogeneous films can be produced or the TPU cannot be processed at all.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the production of melt-processable polyurethane elastomers (TPUs) comprising the steps of:
A) mixing one or more linear, hydroxyl-terminated polyols a) having a weight-average molecular weight of about 500 to about 5,000 with an organic diisocyanate b) in an equivalence ratio of NCO-reactive groups to NCO groups of 1.1:1 to 5.0:1 in a mixing unit with high shear energy;
B) reacting the reaction mixture produced in step A) at temperatures of >about 80° C. to a conversion of >about 90%, based on component b), to form an OH-terminated prepolymer;
C) mixing the OH prepolymer produced in step B) with one or more chain extenders c) having a molecular weight of about 60 to about 490; and
D) reacting the mixture produced in step C) with a quantity of component b) to form the thermoplastic polyurethane, so that, taking all the components into account, an equivalence ratio of NCO groups to NCO-reactive groups of 0.9:1 to 1.1:1 is established,
wherein steps A) to D) are optionally performed in the presence of catalysts and with the optional addition of 0 to about 20 wt. % auxiliary substances and additives, with the weight percentages being based on the total quantity of TPU.

2. The process according to claim 1, wherein polyol a) is selected from the group consisting of polyester polyols, polyether polyols, polycarbonate polyols and mixtures thereof.

3. The process according to claim 1, wherein component c) is selected from the group consisting of ethylene glycol, butanediol, hexanediol, 1,4-di(β-hydroxyethyl) hydroquinone or 1,4-di(β-hydroxyethyl)-bisphenol A and mixtures thereof.

4. The process according to claim 1, wherein the organic diisocyanate b) comprises an aromatic diisocyanate.

5. The process according to claim 1, wherein the organic diisocyanate b) is a mixture of isomers of diphenylmethane diisocyanate with a 4,4′-diphenylmethane diisocyanate content of >about 96%.

6. The process according to claim 1, wherein the organic diisocyanate b) comprises an aliphatic diisocyanate.

7. The process according to claim 1, wherein the organic diisocyanate b) is 1,6-hexamethylene diisocyanate or 4,4′-, 2,4′- or 2,2′-dicyclohexylmethane diisocyanate or the corresponding mixtures of isomers thereof.

8. In a process for the production of injection moldings, the improvement comprising including one or more melt-processable polyurethane elastomers produced by the process according to claim 1.

9. In a process for the production of an extruded article, the improvement comprising including one or more melt-processable polyurethane elastomers produced by the process according to claim 1.
